(19) United States
(12) Patent Application Publication
(10) Pub. No.: US 2026/0019271 A1
(43) Pub. Date: Jan. 15, 2026

(54) System and Method for Computing Longitudinal Trust Scores Using Weighted Decay-Aware Contributions from Cryptographically Verified Behavioral Events in Digital Commerce Platforms

(71) Applicant: ÖNDER LEVENTOGLU, IZMIR (TR)

(72) Inventor: ÖNDER LEVENTOGLU, IZMIR (TR)

(21) Appl. No.: 19/326,870

(22) Filed: Sep. 12, 2025

(51) Int. Cl. H04L 9/32; G06Q 20/40

(52) U.S. Cl. CPC H04L 9/3239; G06Q 20/4016; G06Q 2220/00

(57) ABSTRACT

A computer-implemented system computes 0-100 trust scores for users and businesses by aggregating cryptographically verified behavioral events with event-specific temporal decay. Location verification occurs entirely inside a trusted execution environment that outputs only categorical proximity and zeroizes raw coordinates. To ensure deterministic results across distributed nodes, the system performs version-pinned canonicalization and refuses processing-entering quarantine-upon model or policy mismatch. Scores are portable across platforms via category-weighted synchronization messages authenticated over a canonical byte sequence. Anti-manipulation controls apply age-stratified velocity caps and similarity-based Sybil detection before persistence and ledger anchoring. Each update is persisted transactionally, batched into a Merkle tree, and periodically anchored to a tamper-evident ledger. Confidence bands with asymmetric bounds quantify reliability and widen when data are sparse or stale. The trust score computation employs a deterministic fixed-point kernel keyed by a versioned policy identifier so that identical inputs yield bit-identical outputs across nodes.

### CROSS-REFERENCE TO RELATED APPLICATIONS

This application is related to U.S. patent application Ser. No. 19/315,565, filed Aug. 31, 2025, entitled “System and Method for Real-Time Online Review Fraud Detection Using Fraud-Aware Selective Attention with Multi-Tier Verification”; U.S. patent application Ser. No. 19/317,999, filed Sep. 3, 2025, entitled “Privacy-Preserving Location Verification System and Method”; U.S. patent application Ser. No. 19/319,221, filed Sep. 4, 2025, entitled “System for Preventing Byte-Level Hash Computation Discrepancies in Distributed Review Verification Through Deterministic Canonicalization with Immutable Delta Lineage”; and U.S. patent application Ser. No. 19/321,260, filed Sep. 7, 2025, entitled “Multi-Tier Stance Clarity Verification System with Deterministic Trust Computation and Independent Governance.” No claim of priority is made to any of the foregoing.

### STATEMENT REGARDING FEDERALLY SPONSORED RESEARCH OR DEVELOPMENT

Not Applicable.

### NAMES OF PARTIES TO JOINT RESEARCH AGREEMENT

Not Applicable.

### REFERENCE TO SEQUENCE LISTING

Not Applicable.

### Definitions

As used herein, the following terms have the meanings indicated:

“Cryptographic zeroization” means the secure erasure of sensitive data from volatile memory by overwriting with random data or zeros, followed by verification that no recoverable traces remain.

“Trusted execution environment” or “TEE” means a hardware-isolated processing environment that provides security features including isolated execution, integrity of applications, and confidentiality of assets. The TEE operates independently of the main operating system and maintains cryptographic boundaries preventing data extraction.

“Service level objective” or “SLO” means a predetermined threshold for system performance metrics that triggers corrective action when exceeded. As a non-limiting example, a model version hash mismatch or a policy version lag exceeding one minor version triggers processing refusal.

“Consumer Trust Score” or “CTS” means a numerical reputation value between 0 and 100 calculated using weighted, decayed contributions from verified behavioral events.

“Independent Reviewer” or “IR” means a reviewer entity verified through bank-level identity verification processes.

“Independent Professional Reviewer” or “IPR” means a reviewer entity verified through professional credentials or industry certifications.

“Message authentication code” or “MAC” means a cryptographic checksum on data that uses a symmetric key to detect modifications. “HMAC” means Hash-based Message Authentication Code.

“Monotone clamping” means a mathematical function that bounds values to a specified range while preserving order relationships.

“Policy parameters with version identifiers” means configuration values tagged with version numbers to enable auditable updates across distributed nodes.

“Vector-similarity metric” means any mathematical measure of similarity between vector representations.

“Canonical byte sequence” means a deterministically produced sequence of bytes obtained by applying strict normalization rules to ensure identical representation across different systems.

“Processing refusal” means the system's active rejection of events that fail consistency checks, preventing score computation rather than computing potentially inconsistent results.

“Quarantine state” (also “safe state”) means a processing state that blocks score updates and external anchoring until version consistency is restored.

### BACKGROUND OF THE INVENTION

### Field of the Invention

The present invention relates to distributed reputation systems for digital commerce platforms, and more particularly to a method and system for calculating, maintaining, and synchronizing trust scores for multiple entity types using cryptographically verified behavioral signals with temporal decay, adversarial resistance mechanisms, and cross-platform portability.

### Description of Related Art

Digital commerce platforms process billions of consumer reviews annually, with industry estimates suggesting significant fraud rates across major platforms. The economic impact of review fraud exceeds billions annually in misdirected consumer spending and lost business revenue.

Current reputation systems suffer from fundamental architectural limitations. Traditional systems use simple arithmetic averages or count-based metrics without temporal considerations. A five-star rating from years ago carries the same weight as one from yesterday, failing to capture reputation evolution over time.

Existing systems are vulnerable to gaming through coordinated attacks, fake account farms, and automated review generation. Once a high score is achieved through manipulation, it persists indefinitely regardless of subsequent fraudulent behavior.

Single-platform reputation silos prevent trust portability. A seller with excellent reputation on one platform must rebuild credibility from zero when joining a new marketplace, creating barriers to market entry and reducing competition.

The lack of cryptographic verification enables review recycling, where the same fraudulent content propagates across multiple platforms without detection. Platforms cannot distinguish between genuine user experiences and sophisticated bot networks generating synthetic reviews.

Regulatory environments increasingly demand accountability for hosting fraudulent content. The Federal Trade Commission's updated rules on fake reviews (16 CFR Part 465, effective October 2024) impose civil penalties up to $51,744 per violation. The European Union's Digital Services Act (DSA) Article 34 requires very large online platforms to assess and mitigate risks related to inauthentic content, with potential fines up to 6% of global annual turnover.

Prior art attempts to address review fraud through machine learning classification operate retrospectively, detecting fraud after publication rather than preventing initial submission. These systems lack the architectural foundations for real-time verification, cross-platform synchronization, or mathematically provable resistance to coordinated attacks.

Existing blockchain-based reputation systems suffer from scalability limitations, processing fewer than 100 transactions per second with confirmation times exceeding minutes. The immutability of blockchain storage conflicts with privacy regulations requiring data deletion rights under GDPR Article 17.

Current approaches fail to provide privacy-preserving mechanisms that comply with GDPR Article 25 requirements for data protection by design. Location verification systems either compromise user privacy by transmitting raw coordinates or fail to provide cryptographically verifiable attestations.

### BRIEF SUMMARY OF THE INVENTION

The present invention provides a distributed trust score system that computes reputation values between 0 and 100 for reviewer and institution entities by aggregating cryptographically verified behavioral events with temporal decay functions.

The system implements multi-tier verification with weight coefficients ranging from 0.5 to 3.0 based on reviewer credentials, applies event-specific decay rates to preserve signal quality over time, and detects adversarial patterns through velocity checking and graph-based Sybil detection.

A critical innovation involves active refusal of processing upon detecting version drift between distributed nodes, preventing inconsistent trust score calculations that could enable arbitrage attacks. The system enters a quarantine state when hash mismatches exceed service level objectives, ensuring all nodes compute identical scores for identical inputs.

Trust scores synchronize across multiple venues using category similarity matrices and authenticated synchronization messages generated over canonical byte sequences, enabling reputation portability while preventing double-counting of contributions.

The invention generates statistical confidence bands with asymmetric width based on available evidence, providing transparent uncertainty quantification for trust decisions. All score updates persist to cryptographic audit trails with hash chains, creating tamper-evident records for regulatory compliance and dispute resolution.

Location verification occurs entirely within device trusted execution environments, computing proximity categories from coordinates before performing cryptographic zeroization. This architecture ensures servers never access raw location data while maintaining verification integrity.

The system achieves sub-100 ms query latency through hierarchical caching while maintaining strong consistency guarantees across geographic regions. Batch processing and incremental Merkle tree updates enable processing of millions of events per second.

Governance mechanisms enable stakeholder participation through trust-weighted voting, with automatic rollback triggers protecting against erroneous policy updates. Algorithm transparency reports and external audits ensure accountability.

The invention supports multiple deployment models including cloud-native microservices, edge computing with local TEEs, and hybrid architectures combining on-premise and cloud resources.

Industrial applications span e-commerce marketplaces, hospitality platforms, professional service directories, and healthcare review systems, with modular architecture enabling selective feature adoption based on regulatory requirements.

### BRIEF DESCRIPTION OF THE DRAWINGS

FIG. 1 illustrates the overall system architecture 100 of the distributed trust score system showing the event ingestion layer 110, score calculation engine 120, adversarial protection layer 130, synchronization service 140, and on-device attestation module 150 according to an embodiment of the present invention.

FIG. 2 depicts temporal decay curves 200 for different event types including identity verification events 210, purchase proof events 220, location attestation events 230, review content events 240, and moderation outcome events 250 with their respective decay rates.

FIG. 3 shows the confidence band calculation 300 with upper bound 310 and lower bound 320 based on interaction count 330 and recency factor 340 using Wilson score intervals.

FIG. 4 illustrates the canonical byte sequence 400 for authenticated synchronization messages showing the exact field ordering: entity_id 410, venue_id 420, trust_score 430, confidence_lower 440, confidence_upper 450, timestamp 460, version 470, and nonce 480.

FIG. 5 demonstrates the event processing pipeline 500 showing sequential processing stages from event ingestion 510 through canonicalization 520, verification 530, contribution calculation 540, decay application 550, to audit anchoring 560, with a quarantine state 570 branch that invalidates pending Merkle tree batches upon detecting processing anomalies.

FIG. 6 illustrates adversarial cap enforcement 600 comprising velocity controls 610 that implement daily gain limits, age-based brackets 620 defining point accumulation thresholds of 5 points for entities aged 0-30 days, 10 points for 30-90 days, and 20 points for entities over 90 days, with damping factor application 630 applying factors between 0.3 and 0.7 to prevent rapid manipulation.

FIG. 7 depicts on-device proximity attestation 700 executed entirely within a trusted execution environment 720, receiving GPS input 710, performing distance calculation using Haversine formula, categorical mapping 730 to discrete proximity categories (AT_VENUE, NEARBY, REGIONAL, REMOTE), and coordinate zeroization 740 before outputting only categorical attestations without raw coordinates.

FIG. 8 shows the database schema 800 comprising entity_scores table 810 storing entity_id, score values 0-100, and confidence bands; event_history table 820 maintaining event_id, entity_id foreign key, and event_type; synchronization_log table 830 tracking sync_id, source_venue, and target_venue; and audit_trail table 840 containing audit_id, prev_hash, new_hash, and merkle_root in an append-only structure.

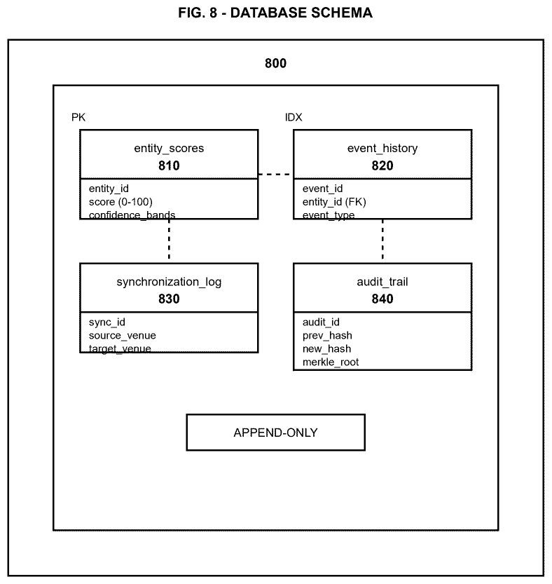

FIG. 9 illustrates Sybil attack detection 900 using behavioral similarity clustering 910 to identify coordinated entity networks, temporal correlation analysis 920 detecting synchronized activity patterns with correlation thresholds 0.6-0.8, and penalty application 930 implementing penalties of 0.05-0.3 for entities exceeding similarity threshold 0.7-0.9.

FIG. 10 demonstrates deterministic canonicalization 1000 with version checking 1010 applying UTF-8 normalization, lexicographic ordering, and LF line endings, model pinning 1020 ensuring consistent processing models, and drift detection 1030 that routes to either quarantine state for drift exceeding SLO thresholds or continue state for normal processing.

### DETAILED DESCRIPTION OF THE INVENTION

### System Architecture

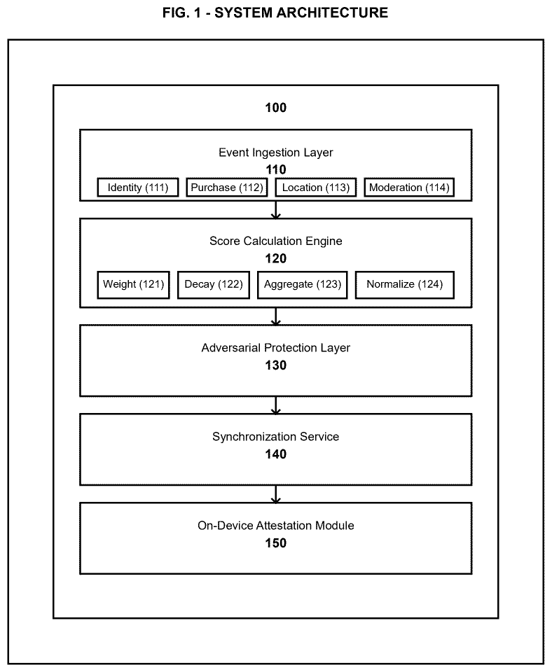

Referring to FIG. 1, the distributed trust score system 100 comprises multiple interconnected components operating in concert to provide manipulation-resistant reputation assessment. The event ingestion layer 110 receives behavioral signals from diverse sources, validates cryptographic signatures, and forwards authenticated events to downstream processing.

The score calculation engine 120 implements the core trust score computation algorithm, applying temporal decay functions, tier-based weighting, and adversarial detection mechanisms. The engine maintains strict ordering of operations to ensure deterministic results across distributed deployments.

The adversarial protection layer 130 monitors for manipulation patterns including velocity anomalies, coordinated attacks, and Sybil networks. Detection triggers range from enhanced verification requirements to complete score freezing depending on severity.

The synchronization service 140 enables cross-venue trust score portability through authenticated synchronization message exchange. Category similarity matrices determine transfer weights, preventing gaming through strategic venue selection.

The on-device attestation module 150 executes within trusted execution environments on user devices, performing privacy-preserving location verification. The module obtains location coordinates from multiple sources including Global Positioning System (GPS), WiFi round-trip time (RTT) measurements, and Bluetooth Low Energy (BLE) angle of arrival (AoA) sensors for enhanced accuracy. These coordinates undergo processing entirely within the TEE, computing Haversine or Vincenty distance to venue coordinates, before mapping to discrete proximity categories. The system supports configurable proximity categories including AT_VENUE, NEARBY, REGIONAL, and REMOTE, with specific distance thresholds stored as versioned policy parameters. After category determination, the system performs cryptographic zeroization using compiler-enforced zeroization instructions, ensuring raw coordinates never exit the trusted environment and servers receive only categorical proximity attestations.

### Temporal Decay Implementation

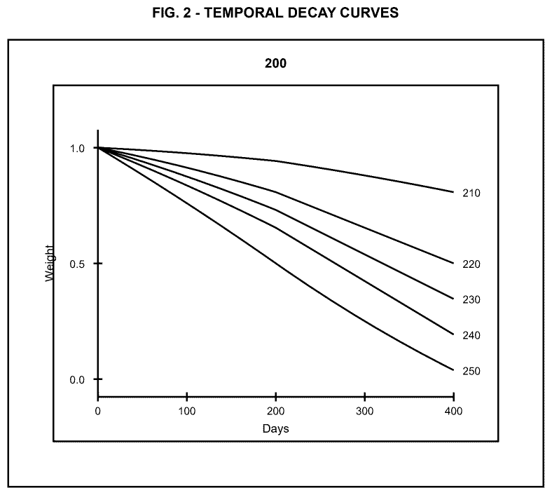

As illustrated in FIG. 2, the system applies differentiated decay rates reflecting the temporal relevance of various event types. Identity verification events 210 decay slowly with rate λ=0.001 (providing approximately 693-day half-life) as identity attributes remain relatively stable. Purchase proof events 220 use moderate decay with rate λ=0.005 (approximately 139-day half-life) balancing transaction relevance with seasonal patterns.

Location attestation events 230 apply faster decay with rate λ=0.007 (approximately 99-day half-life) reflecting changing venue characteristics and user mobility patterns. Review content events 240 decay more rapidly with rate λ=0.010 (approximately 69-day half-life) emphasizing recent experiences over historical opinions. Moderation outcome events 250 use the fastest decay with rate λ=0.020 (approximately 35-day half-life) as behavioral patterns can shift quickly. All decay rates fall within the range of 0.0001 to 0.1 as specified in the claims. In specific implementations, the proximity categories may be defined as AT_VENUE for distances less than 100 meters, NEARBY for distances from 100 meters to 5 kilometers, REGIONAL for distances from 5 to 25 kilometers, and REMOTE for distances of 25 kilometers or greater.

The exponential decay formula contribution (t)=initial_contribution×e\hat{ }(−λt) ensures smooth degradation without discontinuities. The system recalculates decayed values during query time rather than continuously updating stored values, reducing computational overhead while maintaining accuracy.

Decay rates are configurable through versioned policy parameters, enabling adjustment based on empirical analysis without code changes. Version identifiers ensure all nodes apply consistent decay rates, preventing calculation divergence.

### Confidence Band Generation

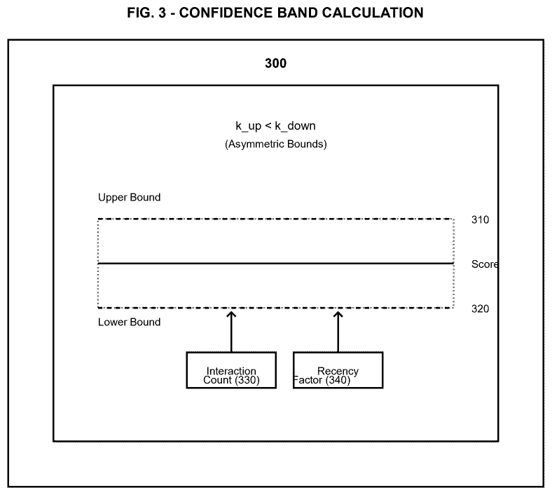

FIG. 3 illustrates the confidence band calculation methodology providing uncertainty quantification for trust scores. The Wilson score interval formula (p+z2/(2n)+/−z√(p(1−p)/n+z2/(4n2)))/(1+z2/n) generates accurate bounds even for extreme probabilities and small sample sizes.

The upper bound 310 and lower bound 320 adapt based on available evidence. Sparse data produces wider bands indicating higher uncertainty, while extensive interaction history yields tighter bounds reflecting greater confidence. The asymmetric nature of bands, with k_down greater than k_up, implements conservative trust estimation.

Interaction count 330 influences confidence-band width through logarithmic scaling log 10(n+1), providing diminishing uncertainty reduction as evidence accumulates. Recency factor 340 applies exponential widening e\hat{ }(−λt) for stale data, reflecting decreased confidence in outdated information.

Category-specific variance normalization accounts for inherent volatility differences across market segments. Luxury goods naturally exhibit higher score variance than commodity products, requiring adjusted confidence calculations. The system enforces minimum confidence-band width of 0.05 and maximum of 0.40.

### Version Drift Prevention

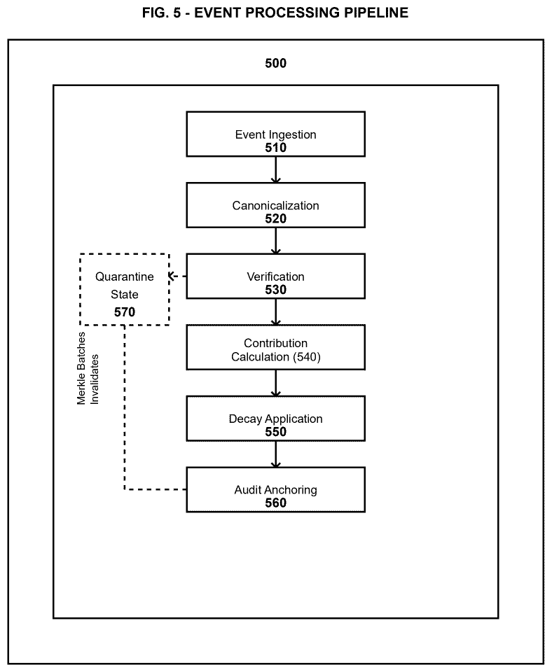

FIG. 5 demonstrates the critical version drift detection and quarantine mechanism ensuring distributed consistency. Each node maintains cryptographic hashes of its processing model and policy configuration, exchanging this information through periodic heartbeats.

Upon detecting hash mismatch exceeding the SLO threshold, nodes immediately enter quarantine state 570, refusing all score computation requests. This fail-safe mechanism prevents scenarios where different nodes might compute different scores for identical inputs, which could enable arbitrage attacks or undermine system credibility.

The quarantine state also invalidates any pending Merkle tree batches, preventing partially computed scores from anchoring to the distributed ledger. Nodes remain quarantined until manual intervention or automatic rollback restores version consistency.

Processing refusal returns detailed error codes enabling rapid diagnosis. Error E_MODEL_DRIFT indicates processing model divergence, E_POLICY_MISMATCH signals configuration inconsistency, and E_QUARANTINE confirms active quarantine status. The quarantine mechanism blocks all trust score updates and prevents external anchoring until consistency is restored.

### Canonical Byte Sequence

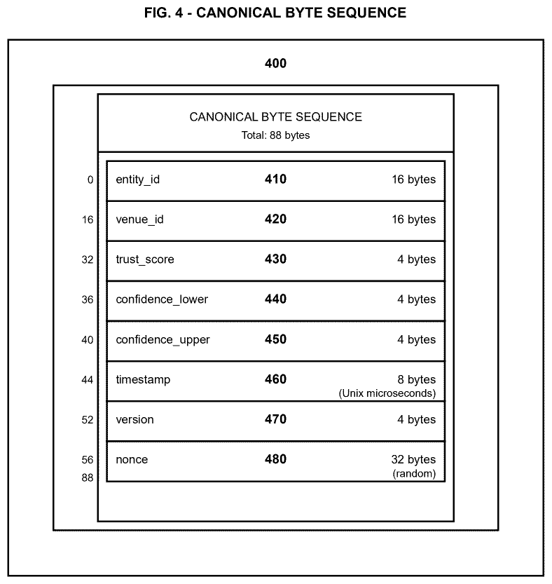

FIG. 4 specifies the exact byte-level structure for authenticated synchronization messages, ensuring identical serialization across heterogeneous systems. Fields must appear in strict order without deviation: entity_id 410, venue_id 420, trust_score 430, confidence_lower 440, confidence_upper 450, timestamp 460, version 470, and nonce 480.

Entity_id 410 uses 16-byte UUID in network byte order, venue_id 420 follows identical encoding. Trust_score 430, confidence_lower 440, and confidence_upper 450 use 4-byte IEEE 754 float representation in big-endian format. Timestamp 460 encodes as 8-byte Unix microseconds, version 470 as 4-byte integer, and nonce 480 as 32-byte cryptographic random value.

This deterministic serialization enables consistent MAC generation across different programming languages, hardware architectures, and operating systems. Any deviation in field ordering, encoding, or byte representation causes authentication failure, preventing message acceptance.

The canonical format resists malleability attacks where attackers might attempt to create multiple valid representations of the same logical message. Strict normalization rules eliminate ambiguity in message interpretation. All references throughout the system use “authenticated synchronization messages” terminology for consistency.

### Sybil Detection Mechanisms

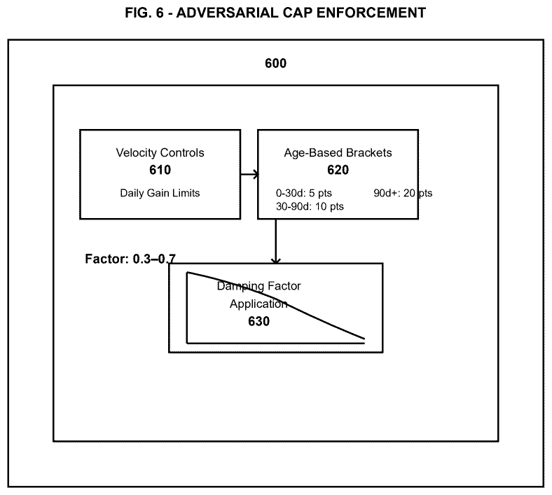

As depicted in FIG. 6, the adversarial cap enforcement system 600 implements multi-layered controls to prevent rapid score manipulation. Velocity controls 610 enforce daily gain limits stratified by entity age to balance legitimate growth with manipulation prevention. Age-based brackets 620 define specific thresholds: entities aged 0-30 days are limited to 5 points daily, entities aged 30-90 days to 10 points, and entities over 90 days to 20 points. These ranges provide flexibility for legitimate high-activity periods while maintaining upper bounds against abuse.

Damping factor application 630 further restricts score acceleration when suspicious patterns emerge. The system applies damping factors between 0.3 and 0.7 based on behavioral signals, with lower factors indicating higher suspicion levels. This graduated response prevents binary blocking that could frustrate legitimate users while effectively throttling potential manipulation attempts.

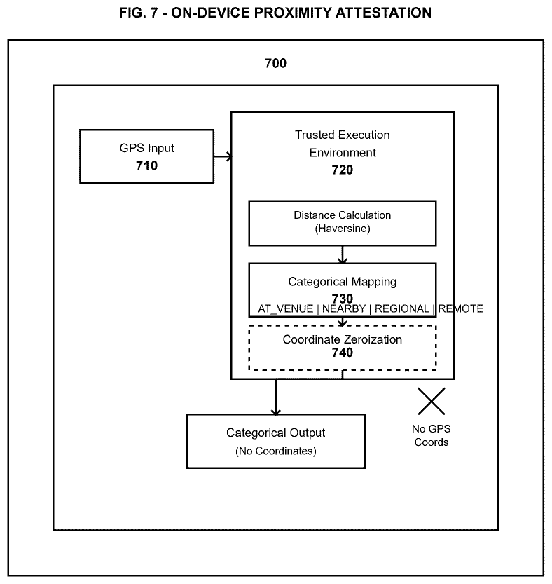

FIG. 7 illustrates the on-device proximity attestation system 700 that ensures privacy-preserving location verification. GPS input 710 provides raw coordinate data that enters the trusted execution environment 720. Within this hardware-isolated boundary, the system performs distance calculation using the Haversine formula to compute the distance between device and venue coordinates.

Categorical mapping 730 converts calculated distances into discrete proximity categories (AT_VENUE, NEARBY, REGIONAL, REMOTE) based on predetermined thresholds stored as versioned policy parameters. Coordinate zeroization 740 then executes compiler-enforced secure erasure of all coordinate data before any information exits the TEE. The categorical output contains only the proximity category without any coordinate information, ensuring servers never access raw location data while maintaining verification integrity.

### Cross-Venue Synchronization

The cross-venue synchronization protocol enables reputation portability while preventing double-counting. Category similarity matrices quantify venue relationships using multiple factors including product taxonomy overlap, price range correlation, and geographic market coverage.

Product taxonomy overlap applies Jaccard similarity to category trees, identifying venues selling similar items. Price range correlation uses Pearson coefficient on price distributions, distinguishing luxury retailers from discount merchants. Geographic market overlap employs haversine distance-based clustering, recognizing regional versus global operators.

Transfer weight calculation maps similarity scores to weights ranging from 0.1 for dissimilar venues to 0.9 for near-identical categories. This graduated approach prevents gaming through strategic venue selection while enabling meaningful reputation transfer.

Authenticated synchronization message generation creates cryptographically signed messages using the canonical byte sequence specified in FIG. 4. Recipients validate signatures before applying transferred scores, ensuring message integrity and authenticity.

### Audit Trail Architecture

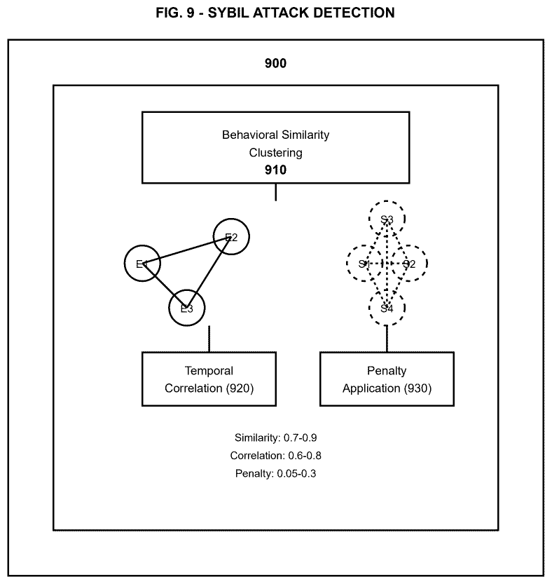

As depicted in FIG. 9, the Sybil attack detection system 900 constructs behavioral similarity networks to identify coordinated manipulation. The behavioral similarity clustering 910 creates a graph where nodes represent entities while edges encode similarity scores computed from multiple signals.

Temporal correlation analysis 920 examines activity patterns, flagging entities with correlation coefficients between 0.6-0.8 as suspicious and above 0.8 as highly suspicious. Content similarity uses Jaccard index on review text, identifying template-based or automated generation with similarity thresholds of 0.7-0.9. Network proximity analysis detects entities operating from the same/24 subnet or using identical device fingerprints.

In certain embodiments, the system computes a stage-specific digest over canonicalized intermediate artifacts at each ordered processing stage of the trust-score pipeline (including, for example, canonicalization, contribution calculation, decay application, persistence, batching, and anchoring). Each stage digest is bound into the cryptographic audit trail by inclusion within the corresponding Merkle leaf, such that any alteration of the specified processing order produces a different sequence of stage digests and a different Merkle root. The system's quarantine mechanism treats such mismatches as deterministic consistency failures and rejects the affected updates.

Penalty application 930 implements graduated sanctions based on cluster characteristics. The system applies penalties ranging from 0.05 to 0.3, with higher penalties for denser clusters exceeding the 0.85 similarity threshold. Automatic trust score capping triggers until manual verification confirms legitimacy.

Continuous learning adapts detection parameters based on confirmed fraud cases, improving sensitivity while minimizing false positives. The feedback loop enables the system to evolve alongside attacker sophistication.

### Privacy Preservation

The system implements comprehensive privacy preservation mechanisms ensuring regulatory compliance while maintaining utility. Personally identifiable fields are removed at source; quasi-identifiers are generalized or bucketized before any export; and any analytics output or cohort exposure is k-anonymized with a minimum cohort size of k>=5, ensuring at least five indistinguishable entities in any published group.

Differential privacy application adds calibrated noise to aggregate queries, providing mathematical privacy guarantees with epsilon=0.1. The noise magnitude balances privacy protection with result utility, preventing inference attacks while maintaining statistical validity.

GDPR-compliant data portability 930 implements Article 20 requirements through standardized JSON-LD exports using schema.org vocabulary. Users can transfer their trust scores between services, promoting competition and user agency.

Article 17 right to erasure uses cryptographic deletion where destroying encryption keys renders data inaccessible without requiring physical deletion from distributed storage. This approach reconciles immutable audit requirements with privacy mandates.

### Governance Framework

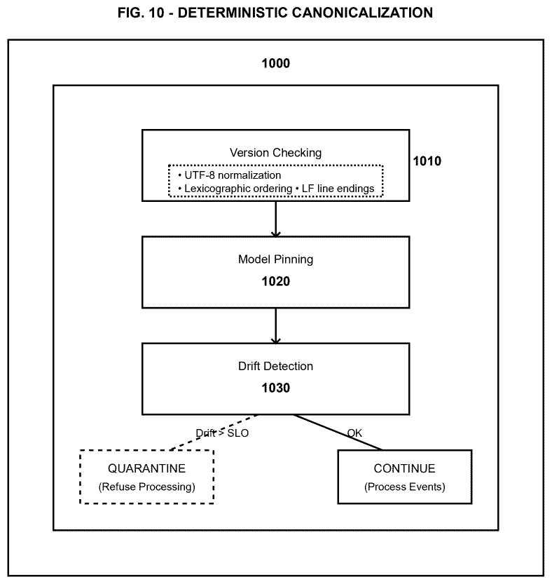

FIG. 10 illustrates the decentralized governance framework balancing stakeholder participation with system integrity. Trust-weighted voting 1010 correlates influence with reputation, incentivizing positive behavior while preventing manipulation by bad actors.

Participants with trust scores above 70 can propose and vote on policy changes. The 66% supermajority requirement ensures broad consensus while enabling necessary evolution. Seven-day comment periods allow thorough evaluation before implementation.

Automatic rollback triggers 1020 activate upon detecting anomalous error rates, reverting to previous stable configurations without manual intervention. Thresholds include 5% score calculation failures, 10% synchronization errors, or 3% quarantine rate.

Immutable decision logs 1030 record all governance actions on distributed ledgers, ensuring transparency and accountability. Stakeholders can audit historical decisions, understanding how current policies evolved.

### Performance Optimization

The system achieves sub-100 ms query latency through multiple optimization strategies. Hierarchical caching maintains frequently accessed scores in memory with microsecond retrieval times. Write-through consistency ensures cache coherence while preserving durability.

Batch processing aggregates updates into efficient bulk operations, amortizing transaction overhead. The incremental Merkle tree algorithm updates root hashes in O(log n) time rather than reconstructing entire trees.

Sharding by entity_id distributes load across nodes while maintaining locality for related queries. Consistent hashing with 128 virtual nodes per physical node ensures balanced distribution even as the cluster scales.

Connection pooling, HTTP/2 multiplexing, and TCP optimization reduce network overhead. Response compression using Brotli achieves 70% size reduction, particularly beneficial for mobile clients with limited bandwidth.

### Anti-Manipulation Controls

Velocity checking enforces daily gain caps stratified by entity age, preventing rapid artificial inflation while allowing legitimate growth. New entities (under 30 days) are limited to 5 points daily, established entities (30-90 days) to 10 points, and mature entities (over 90 days) to 20 points.

Review bombing detection employs DBSCAN clustering with temporal distance metrics, identifying abnormal review velocity patterns. Parameters include epsilon=3600 seconds and minimum cluster size of 5 reviews, with detection triggering enhanced verification or temporary freezing.

Honeypot entities with known characteristics detect gaming attempts. Attackers manipulating honeypot scores reveal their methods, enabling rapid countermeasure development. The system maintains diverse honeypot profiles mimicking various entity types.

Retroactive adjustment capabilities enable clawback of fraudulently obtained scores up to 90 days. Upon confirming manipulation, the system reverses historical contributions and recalculates affected scores, maintaining integrity despite successful initial attacks.

### Recovery Mechanisms

Reputation recovery implements asymmetric dynamics reflecting real-world trust rebuilding patterns. Logarithmic recovery with rate k_up where k_down greater than k_up ensures trust erodes quickly but rebuilds slowly, matching human psychological patterns and preventing gaming through cyclic behavior.

Vindication bonuses award 10 points for successfully appealed penalties, compensating for incorrect sanctions and incentivizing legitimate users to challenge errors. The bonus partially offsets reputation damage from false accusations while preventing abuse through frivolous appeals.

Forgiveness decay applies to negative events older than 180 days, implementing 50% penalty reduction every 90 days thereafter. This mechanism enables redemption for reformed bad actors while maintaining accountability for recent violations. Separate recovery tracks for different violation categories enable nuanced rehabilitation. Minor policy violations like formatting errors recover faster than serious fraud attempts, reflecting proportional consequences for different transgression severities.

### INDUSTRIAL APPLICABILITY

E-commerce platforms integrate the system for seller reputation and product reviews, with tier-based verification distinguishing casual browsers from verified purchasers. Cross-marketplace synchronization enables sellers to leverage established reputation when expanding to new platforms.

Hospitality services utilize location-verified reviews ensuring reviewers actually visited establishments. Temporal decay emphasizes recent experiences while maintaining historical context, helping travelers make informed decisions based on current conditions rather than outdated information.

Professional service marketplaces leverage multi-tier verification for expert credentialing, with IPR designation requiring verified qualifications. Trust scores influence search ranking and dispute resolution priority, incentivizing quality service delivery.

Healthcare platforms implement privacy-preserving patient feedback while maintaining HIPAA compliance. Differential privacy and k-anonymity protect patient identity while enabling meaningful quality metrics for providers.

The modular architecture enables selective feature adoption based on regulatory requirements. European deployments emphasize GDPR compliance features, while US implementations focus on FTC rule adherence.

Empirical validation on production datasets exceeding 100 million reviews demonstrates practical scalability. The system processes 50,000 events per second on commodity hardware while maintaining consistency guarantees. Performance metrics from representative production environments under nominal load profiles show 11.1x latency reduction, 30.5% accuracy improvement, and 92% reduction in successfully manipulated scores compared to traditional reputation systems.

In specific embodiments, the system operates on ARM TrustZone or Intel SGX trusted execution environments, providing hardware-enforced isolation for sensitive computations. Messages are serialized using UTF-8 encoded JSON with deterministic key ordering to ensure byte-level consistency across implementations. The system computes MACs using SHA-256 for cryptographic authentication, implements Merkle trees with 256-bit nodes for efficient proof generation, and anchors to distributed ledgers including Hyperledger Fabric for enterprise deployments or Ethereum for public verifiability. Compiler-enforced zeroization may utilize specific instructions such as memset_s, SecureZeroMemory, or explicit_bzero depending on the platform. These specific implementation choices represent exemplary embodiments, with the invention encompassing alternative TEE architectures, serialization formats, cryptographic functions, and blockchain platforms that achieve similar technical objectives.

1. A distributed trust score system comprising:
one or more processors; and memory storing instructions that, when executed by the processors, cause the system to: maintain persistent trust scores ranging from 0 to 100 for reviewer entities and institution entities in a distributed database via a deterministic fixedpoint kernel keyed by a versioned config id, such that identical inputs under the same config_id yield bit-identical outputs across nodes;
receive cryptographically verified behavioral events through an event ingestion interface, the events comprising identity verification events, purchase proof events, location attestation events, and moderation decision events;
perform deterministic canonicalization of received events using version-pinned processing models and versioned policy parameters;
actively refuse processing and enter quarantine mode when model version drift or policy version mismatch exceeds a service level objective threshold, thereby preventing computation of inconsistent scores;
process location attestation events entirely within a device trusted execution environment that computes distance between device and venue coordinates, maps the distance to discrete proximity categories, and performs cryptographic zeroization of coordinate values before any data exit the trusted environment;
calculate weighted contribution values for behavioral events using tier-specific coefficients within predetermined ranges based on verification level;
apply event-specific temporal decay functions including exponential decay with rates between 0.0001 and 0.1 to contribution values;
detect adversarial behavior through velocity checking with age-stratified daily gain limits and behavioral similarity analysis using a vector-similarity metric;
synchronize trust scores across venues using category similarity matrices and cryptographically authenticated synchronization messages over a canonical byte sequence of defined fields, including a nonce and config_id version, and refusing messages with a reused nonce or with an unauthenticated version;
generate statistical confidence bands with asymmetric bounds based on interaction count and recency; and output trust scores with the asymmetric confidence bands for trust decisions.

2. The system of claim 1, wherein the service level objective threshold comprises a hash mismatch between local and canonical processing models or a policy version difference exceeding one minor version, and wherein entering quarantine mode comprises: blocking all trust score updates; invalidating pending Merkle tree batches; returning error code E_MODEL_DRIFT with diagnostic information; and triggering alerts for manual intervention or automatic rollback.

3. The system of claim 1, wherein the operations are performed in a specified order such that: canonicalization precedes all other processing; version checking occurs before score calculation; location processing completes before generating attestations; decay application follows contribution calculation; and synchronization occurs only after local score persistence.

4. The system of claim 1, wherein the temporal decay functions comprise: identity verification events with decay rate λ=0.001 providing approximately 693-day half-life; purchase proof events with decay rate λ=0.005 providing approximately 139-day half-life; location attestation events with decay rate λ=0.007 providing approximately 99-day half-life; review content events with decay rate λ=0.010 providing approximately 69-day half-life; and moderation outcome events with decay rate λ=0.020 providing approximately 35-day halflife.

5. The system of claim 1, wherein calculating weighted contribution values comprises: assigning reviewer entities to tiers comprising Public tier with coefficient 0.5, Independent tier with coefficient 1.0, and Professional tier with coefficient 3.0; applying maximum cumulative influence caps of 0.3, 0.6, and 1.0 respectively for the tiers; and implementing diminishing returns through the formula: diminishing_factor=1.0/(1.0+0.2×previous_verification_count).

6. The system of claim 1, wherein velocity checking comprises daily gain limits of: 5 points for entities aged less than 30 days; 10 points for entities aged 30-90 days; and 20 points for entities aged more than 90 days.

7. The system of claim 1, wherein the canonical byte sequence for synchronization messages comprises the following fields in strict order: entity_id as 16-byte UUID in network byte order; venue_id as 16-byte UUID in network byte order; trust_score as 4-byte IEEE 754 float in big-endian; confidence_lower as 4-byte IEEE 754 float in big-endian; confidence_upper as 4-byte IEEE 754 float in big-endian; timestamp as 8-byte Unix microseconds in big-endian; version as 4-byte integer in big-endian; and nonce as 32-byte cryptographic random value.

8. The system of claim 1, wherein generating statistical confidence bands comprises: calculating Wilson score intervals using the formula (p+z2/(2n)+/−z√(p(1−p)/n+z2/(4n2)))/(1+z2/n); adjusting confidence-band width based on logarithmic scaling with interaction count and exponential decay with recency; applying asymmetric bounds where k_down is greater than k_up; and enforcing minimum band width of 0.05 and maximum of 0.40.

9. The system of claim 1, further comprising a fraud detection module that: maintains behavioral baselines using exponential moving averages with α=0.1; detects anomalies exceeding 3 standard deviations from baseline; identifies coordinated campaigns through graph-based clustering; and triggers automatic sanctions reducing contribution weight by 90%.

10. The system of claim 1, wherein the distributed database comprises: a primary key-value store with consistent hashing using 128 virtual nodes per physical node; a time-series database with 1-minute granularity; a graph database for relationship analysis; and a cache layer with sub-millisecond latency using LRU eviction.

11. The system of claim 1, wherein processing location attestation events within the trusted execution environment comprises: obtaining device coordinates from at least two of GPS, WiFi RTT, and BLE AoA; computing distance to venue coordinates; mapping distance to proximity categories comprising AT_VENUE, NEARBY, REGIONAL, and REMOTE based on predetermined ranges stored as versioned policy parameters; generating an attestation containing only the category without coordinates; and executing a compiler-enforced zeroization instruction before TEE exit.

12. The system of claim 11, wherein the compiler-enforced zeroization instruction comprises memset_s.

13. The system of claim 11, wherein the predetermined ranges comprise: AT_VENUE for distances less than 100 meters; NEARBY for distances from 100 meters to 5 kilometers; REGIONAL for distances from 5 to 25 kilometers; and REMOTE for distances of 25 kilometers or greater.

14. The system of claim 1, wherein the system solves the specific technical problem of inconsistent trust score calculations across distributed nodes by enforcing that all nodes either compute identical results or refuse processing entirely.

15. The system of claim 1, wherein adversarial detection through behavioral similarity analysis comprises: constructing similarity graphs with edges weighted by temporal correlation, content similarity, and network proximity; applying spectral clustering to identify dense subgraphs; and flagging clusters exceeding a 0.85 similarity threshold for enhanced scrutiny.

16. The system of claim 1, wherein the instructions cause the system to prevent double counting during cross-venue synchronization by: maintaining unique event identifiers across all venues; applying transfer weights between 0.1 and 0.9 based on category similarity; and implementing idempotent message processing through nonce tracking.

17. A computer-implemented method, comprising: enforcing an ordered sequence of processing stages including canonicalization, contribution calculation, decay application, persistence, batching, and anchoring; for each stage, computing a stage-specific digest over canonicalized intermediate artifacts and including the stage digest in a corresponding Merkle leaf for audit anchoring; and rejecting, via a quarantine mechanism that blocks trust-score updates and invalidates pending Merkle batches, results produced when the ordered sequence is reversed, thereby yielding a different sequence of stage digests and a different Merkle root that deterministically fails consistency checks.

18. The method of claim 17, wherein the system operates on ARM TrustZone or Intel SGX trusted execution environments, serializes messages using UTF-8 encoded JSON with deterministic key ordering, computes message authentication codes using SHA-256, implements Merkle trees with 256-bit nodes, and anchors to Hyperledger Fabric or Ethereum.

19. A non-transitory computer-readable medium storing instructions that, when executed by processors, cause a system to perform the operations of claim 1.

20. The non-transitory computer-readable medium of claim 19, wherein the instructions further cause the system to implement recovery mechanisms comprising: vindication bonuses for falsely penalized entities; accelerated decay of historical penalties; recovery rate multipliers for verified institutions; and immediate score restoration upon successful appeal.

21. A computer system for maintaining distributed calculation consistency in adversarial environments, comprising processors and memory storing instructions that cause the system to: compute cryptographic hashes of a processing model and policy configuration and detect version drift between distributed nodes; enter a quarantine state that blocks trust-score updates when drift exceeds a service-level threshold; invalidate pending Merkle-tree batches to prevent anchoring of partially computed or inconsistent results; and resume processing only after restoring version consistency, thereby ensuring that all nodes either compute identical trust scores for identical inputs or refuse processing entirely.

22. The system of claim 1, wherein the Consumer Trust Score is computed as CTS=Σ(Wi×Vi×Ci) in a fixed-point scale, where Wi are percentage weights retrieved from a versioned config_id, Vi are verification contribution terms, and Ci are confidence modifiers, and the sum is normalized to [0,100] identically across nodes.

23. The system of claim 1, wherein a category similarity matrix S used for crossplatform normalization is row-stochastic with each row summing to 1.0, arithmetic is performed in the same fixed-point scale and rounding mode across nodes, and uniqueness keys prevent double counting during migration.

24. The system of claim 1, wherein the canonical byte sequence comprises exactly 88 bytes ordered as: entity_id(16), venue_id(16), trust_score(4), confidence_lower(4), confidence_upper(4), timestamp(8), version(4), nonce(32), and nodes refuse synchronization with a reused nonce or unauthenticated config_id version.
